(19) United States
(12) Patent Application Publication
(10) Pub. No.: US 2026/0186298 A1
(43) Pub. Date: Jul. 2, 2026

(54) HYBRID EYE-TRACKING DEVICE AND LABORATORY CALIBRATION METHOD AND FIELD CALIBRATION METHOD FOR CALIBRATING THE HYBRID EYE-TRACKING DEVICE

(71) Applicant: Robert Bosch GmbH, Stuttgart (DE)

(72) Inventors: Johannes Meyer, Haseluenne (DE); Stefan Gering, Weissach (DE)

(21) Appl. No.: 18/861,986

(22) PCT Filed: Jul. 12, 2023
(86) PCT No.: PCT/EP2023/069265

§ 371 Date: Oct. 31, 2024

(30) Foreign Application Priority Data
Oct. 20, 2022 (DE) 10 2022 211 128.1

(51) Int. Cl. G02B 27/00; G02B 27/01

(52) U.S. Cl. CPC G02B 27/0093; G02B 27/0172; G02B 2027/0138; G02B 2027/0178

(57) ABSTRACT

A hybrid eye-tracking device, in particular high-speed hybrid eye-tracking device, preferably in a pair of data glasses, for determining an instantaneous eye position, in particular of an eye of a user of the data glasses. The device includes at least one camera sensor and at least one laser feedback interferometry (LFI) sensor. The camera sensor is configured at least to determine an eye position from a camera image. The LFI sensor is configured at least to determine an instantaneous velocity, in particular of an eye movement.

### BACKGROUND INFORMATION

Certain data glasses with eye-tracking devices are described in the related art. They generally require initial calibration during assembly and, if necessary, recalibration in the field.

### SUMMARY

Provided according to the present invention is a hybrid eye-tracking device, in particular a high-speed hybrid eye-tracking device, preferably in a pair of data glasses, for determining an instantaneous eye position, in particular of an eye of a user of the pair of data glasses. According to an example embodiment of the present invention, the drive includes at least one camera sensor and with at least one laser feedback interferometry (LFI) sensor, in particular with two LFI sensors, wherein the camera sensor is configured at least to determine an eye position from a camera image, and wherein the LFI sensor, in particular the LFI sensors, is configured at least to determine an instantaneous velocity, in particular of an eye movement. Particularly fast and yet very precise eye tracking can advantageously be made possible thereby. In particular, eye tracking with an update rate of more than 1 kHz, preferably more than 10 kHz, and preferably more than 100 kHz, can be made possible thereby. By fusion of the position of the eye from a camera image (frame) of the camera sensor, an absolute position of the eye can in particular be determined by means of the hybrid eye-tracking device, while intermediate positions of the eye between images of frames of the camera sensor can advantageously be integrated via a velocity measurement of the LFI sensor. In particular, the pair of data glasses comprises a computer unit configured to determine the instantaneous eye positions taken between the individual successive camera images (frames) of the camera sensor, in particular by means of integration, from the instantaneous velocities measured by the LFI sensors. A “high-speed eye-tracking device” is in particular understood to mean an eye-tracking device with an update rate of the eye position of more than 1 kHz, preferably more than 10 kHz, and preferably more than 100 kHz.

A “pair of data glasses” is in particular to be understood as a wearable (head-mounted display), by means of which information can be added to the field of view of a user. Data glasses preferably make augmented reality applications and/or mixed reality applications possible. Data glasses are also commonly referred to as smart classes. In particular, the pair of data glasses comprises the virtual retinal scan display (also known as a light field display), which is in particular generally known to a person skilled in the art. In particular, the pair of data glasses, preferably the virtual retinal scan display, comprises a laser projector. In particular, the LFI sensor can be designed to be integrated into the laser projector or can be arranged, separated from the laser projector, in the pair of data glasses. The pair of data glasses may comprise at least one or more further LFI sensors. The LFI sensor(s) and the camera sensor may be arranged in a common plane, in particular in a glasses lens plane of the pair of data glasses. Alternatively, the LFI sensor(s) and the camera sensor may be arranged in different planes. Preferably, the LFI sensor(s) and the camera sensor are arranged and/or aligned to one another at least such that they are aligned to be able to capture data from the eye (images or velocity and/or distance). LFI sensors are in particular sensors that are based on an effect of self-mixing or back-injection laser interferometry that is known to the person skilled in the art. In particular, a sensor signal is generated in the LFI sensor in that a laser signal is reflected, in particular by the user eye, into a laser resonator of the LFI sensor that preferably already generates the output laser signal, and thereby modulates the output laser signal, in particular an amplitude and/or a frequency of the output laser signal. Advantageously, costs can be reduced by using LFI sensors. In particular, the LFI sensor can comprise a photodiode, which can detect the reflected laser signal. In particular, the photodiode is integrated into the laser projector, in particular into the laser (infrared laser), preferably into the laser resonator of the laser (infrared laser). For example, the laser (infrared laser) can comprise a ViP-VCSEL (vertical-cavity surface-emitting laser with integrated photodiode) or be designed as a ViP-VCSEL. Preferably, the LFI sensor is provided to detect an instantaneous velocity of the eye movement of the user eye. Preferably, the LFI sensor is provided to detect a change in velocity of the eye movement of the user eye transversely to an emission direction of the output laser signal. In order to ascertain the instantaneous velocity of the eye movement of the user eye, it may therefore be necessary to track an impingement angle between an eye surface of the user eye and an axis of rotation of the user eye, which in particular requires knowledge of an exact position of the laser of the LFI sensor in an optical system, in particular in the pair of data glasses, preferably in the glasses frame of the pair of data glasses. In particular, the laser of the LFI sensor is designed as an infrared laser. The terms “provided” and/or “configured” are in particular understood to mean specifically programmed, designed, and/or equipped. An object being provided for a particular function is understood in particular to mean that the object fulfills and/or performs this particular function in at least one application state and/or operating state.

According to an example embodiment of the present invention, it is furthermore provided that the LFI sensor has a significantly lower resolution and a significantly higher sampling rate than the camera sensor. This can advantageously keep energy consumption low, even at a particularly high update rate. In particular, the LFI sensor is designed as a high-speed LFI sensor. In particular, the camera sensor is designed as a high-precision camera sensor, preferably as a high-precision infrared camera sensor, in particular with an update rate of 0.1 Hz to at most 100 Hz. Since the camera sensor in particular has a comparatively high energy consumption or power consumption and the LFI sensor has a comparatively low energy consumption or power consumption, the provided combination of the two sensors can advantageously optimize the energy consumption with a simultaneously high update rate.

In addition, a laboratory calibration method for calibrating the hybrid eye-tracking device and/or a hybrid eye-tracking method is provided according to the present invention, wherein a position of the LFI sensor in a coordinate system of the camera sensor is determined by using the camera sensor to ascertain positions of a laser point, generated by the LFI sensor, on a, preferably planar and preferably monochrome, laboratory calibration target at different definable known distances of the laboratory calibration target from the camera sensor in the coordinate system of the camera sensor. This advantageously can make precise end-of-line calibration of the hybrid eye-tracking device possible in a fast and simple manner. Advantageously, this can reduce tolerance costs in production, in particular since the hybrid eye-tracking device, preferably the pair of data glasses, can be precisely calibrated at the end of the manufacturing process. In particular, the laboratory calibration target can be a simple monochrome, e.g., black, surface or comprise a checkerboard pattern, e.g., a ChArUco pattern. The laboratory calibration method is preferably performed at an end of a manufacturing line for hybrid eye-tracking devices, in particular for virtual retinal scan displays, preferably for data glasses. In particular, the laboratory calibration method forms an end-of-line calibration method for data glasses. In particular, in order to perform the laboratory calibration method, the hybrid eye-tracking device, in particular the virtual retinal scan display, preferably the pair of data glasses, is first positioned in front of the laboratory calibration target. In particular, the laboratory calibration target is filmed by the camera sensor while the LFI sensor radiates onto the laboratory calibration target. In particular, the camera sensor captures the point of impingement of the output laser signal on the laboratory calibration target. In particular, the point of impingement of the output laser signal shifts when the laboratory calibration target is moved by means of the precision linear axis. It is possible that multiple LFI sensors simultaneously radiate onto the laboratory calibration target and are simultaneously or sequentially calibrated to the camera sensor by means of the laboratory calibration method. In particular, all LFI sensors of the hybrid eye-tracking device of the pair of data glasses are simultaneously or sequentially calibrated by means of the laboratory calibration method. In particular, the pair of data glasses can comprise at least two LFI sensors, wherein each sensor is preferably assigned a different one of the two user eyes of the user of the pair of data glasses.

According to an example embodiment of the present invention, in the laboratory calibration method, when the laboratory calibration target is moved on a precision linear axis during calibration so that the corresponding relative distances of the laboratory calibration target can be read directly by the camera sensor, a fast, simple and precise end-of-line calibration of the hybrid eye-tracking device can advantageously be made possible. In particular, a travel path of the precision linear axis can be read precisely. The reading can in particular take place automatically, e.g., via the computing unit. Alternatively, manual reading may also be provided. In particular, in the laboratory calibration method, only the change in relative distance of the laboratory calibration target from the camera sensor is known if a movement axis of the precision linear axis and a camera axis of the camera sensor are not on the same axis. In the event that the axes coincide, even absolute changes in distance could be ascertainable, but this is not absolutely necessary for performing the laser calibration method.

According to an example embodiment of the present invention, if, in the laboratory calibration method in at least one laboratory calibration step, the LFI sensor also ascertains a distance between the LFI sensor and the laboratory calibration target at the location of the laser point, in particular at the point of impingement of the output laser signal on the laboratory calibration target, a fast, simple and precise end-of-line calibration of the hybrid eye-tracking device can advantageously be made possible. In particular, for this purpose, the LFI sensor is operated via a triangular modulation, for example similarly to an FMCW radar (continuous wave radar), whereby the LFI sensor is able to measure the distance between a laser exit facet of the LFI sensor and the point of impingement of the output laser signal on the laboratory calibration target.

According to an example embodiment of the present invention, if a unit vector of a beam direction of the LFI sensor is also ascertained from horizontal and/or vertical pixel distances between images of the same laser point at the different distances of the laboratory calibration target from the camera sensor in the laboratory calibration method in at least one laboratory calibration step, a fast, simple and precise end-of-line calibration of the hybrid eye-tracking device can advantageously be made possible. The camera is in particular designed as a calibrated camera. In particular, the position of the laser point has shifted in the vertical direction (Δy) and in the horizontal direction (ΔX) as a result of the movement along the precision linear axis (Δz). While Δz is advantageously already known from the travel path of the precision linear axis, Δy and Δx (each with respect to a center of the laser point on the laboratory calibration target) are measured in pixels from the camera images. By using the calibrated camera, the distance in pixels can then be advantageously converted into an absolute distance and the unit vector in the laser beam direction of the output laser signal can thus be determined. From a consideration of the ascertained distance between the LFI sensor and the laboratory calibration target and the ascertained unit vector of the beam direction of the LFI sensor, the position of the LFI sensor with respect to the coordinate system of the camera sensor is then determined in at least one further calibration step. In particular, the measured distance from LFI sensor to laboratory calibration target is used as the absolute vector length in the coordinate system of the camera sensor. In particular, the unit vector is used as the vector direction in the coordinate system of the camera sensor.

Furthermore, a field calibration method for calibrating the hybrid eye-tracking device is provided according to an example embodiment of the present invention, wherein a position of the LFI sensor, in particular of at least one of the LFI sensors, in a coordinate system of the camera sensor is determined by using the camera sensor to ascertain positions of a laser point, generated by the LFI sensor, on a defined and known calibration pattern of an, in particular planar, field calibration target, preferably checkerboard pattern target, preferably ChArUco pattern target, at different unknown distances of the field calibration target from the camera sensor in the coordinate system of the camera sensor. This advantageously makes precise field calibration of the hybrid eye-tracking device possible in a fast and simple manner. Advantageously, high user friendliness can be achieved. For example, by means of the field calibration method, a recalibration, which has, for example, become necessary as a result of a fall or an adjustment of the pair of data glasses, can advantageously be performed. In particular, the calibration pattern of the field calibration target is printable (by means of a commercially available printer). Alternatively, the calibration pattern of the field calibration target may also be displayed on a screen. In particular, the defined and known calibration pattern of the field calibration target is provided at least to make calibration of the camera possible, for example by shapes or patterns of known defined sizes. In particular, the defined and known calibration pattern of the field calibration target is provided at least to ascertain a determination of an alignment of the calibration target in space relative to the LFI sensor, for example through a regularly repeated arrangement of certain identical pattern elements. The ChArUco pattern target is a specific checkerboard pattern combined with elements from the augmented reality library of the University of Cordoba (ArUco). First, in the field calibration method, the calibration (recalibration) of the camera sensor is performed (again). For this purpose, markers of the defined and known calibration pattern, e.g., the ArUco elements of the ChArUco pattern, are recognized in the camera image of the camera sensor. By means of these recognized markers, a calibration matrix K of a pinhole camera model and an associated distortion vector b are then calculated.

$$K = [ \begin{matrix}{f}_{x} & 0 & {c}_{x} \\ 0 & {f}_{y} & {c}_{y} \\ 0 & 0 & 1\end{matrix} ]$$

$$b = [ {k}_{1} {k}_{2} {p}_{1} {p}_{2} {k}_{3} ]$$

Subsequently, the laser of the LFI sensor is turned on and the laser point on the field calibration target is detected by means of the camera sensor from the camera images.

According to an example embodiment of the present invention, if, in at least one field calibration step, the LFI sensor then ascertains a distance between the LFI sensor and the checkerboard pattern target at the location of the laser point, a fast, simple and precise field calibration of the hybrid eye-tracking device can advantageously be made possible. The distance to the field calibration target is ascertained analogously to ascertaining the distance to the laboratory calibration target in the laboratory calibration method.

According to an example embodiment of the present invention, if, in at least one further field calibration step, a spatial position and orientation of the field calibration target, preferably the checkerboard pattern target, preferably the ChArUco pattern target, in the coordinate system of the camera sensor are also ascertained by means of a checkerboard camera calibration on the basis of a camera image of the camera sensor, a fast, simple and precise field calibration of the hybrid eye-tracking device can advantageously be made possible. For this purpose, a normal vector of the field calibration target in camera coordinates is preferably determined from a plurality of marker vectors tₘ₁ to tₘ₄ pointing to different markers of the field calibration target, e.g., the corners of the outermost checkerboard fields. In particular, the marker vectors and the points of impingement of the marker vectors on the field calibration target are determined from the pinhole camera model and a virtual image plane 1. A normal vector of the field calibration target (and thus a pose of the field calibration target in the camera coordinate system) can in particular be determined from the marker vectors as a result, in particular by means of the following formula.

$$\vec{n} = ( {\vec{t}}_{m 1} - {\vec{t}}_{m 2} ) x ( {\vec{t}}_{m 3} - {\vec{t}}_{m 1} )$$

Preferably, according to an example embodiment of the present invention, a laser vector t₁, pointing to the point of impingement of the output laser signal on the field calibration target, in camera coordinates

$$\vec{{t}_{l}} = [ \begin{matrix}{x}_{l} \\ {y}_{l} \\ {z}_{l}\end{matrix} ] = [ \begin{matrix}\frac{{u}_{l} - {c}_{x}}{{f}_{x}} \\ \frac{{v}_{l} - {c}_{y}}{{f}_{y}} \\ 1\end{matrix} ]$$

as well as its intersection point with the image plane

$$d = \frac{( {p}_{0} - {l}_{0} ) \vec{n}}{\vert {\vec{t}}_{l} \vert \vec{n}}$$

$${\vec{t}}_{lp} = {l}_{0} + \vert {\vec{t}}_{l} \vert$$

are subsequently determined.

According to an example embodiment of the present invention, it is furthermore provided that, in at least one further field calibration step, on the basis of the ascertained spatial position and orientation of the field calibration target, in particular checkerboard pattern target, a virtual sphere, the center of which is formed by the laser point, in particular in camera coordinates, on the field calibration target, in particular checkerboard pattern target, and the radius of which is formed by the, in particular measured, distance between the LFI sensor and the field calibration target, in particular checkerboard pattern target, at the location of the laser point, is spanned in the coordinate system of the camera sensor. This can advantageously make a fast, simple and precise field calibration of the hybrid eye-tracking device possible.

According to an example embodiment of the present invention, if, in the further field calibration step, for at least three unknown distances, in particular poses, of the field calibration target, in particular of the checkerboard pattern target, from the camera sensor, a separate sphere is in each case spanned in the coordinate system of the camera sensor so that the position of the LFI sensor in a coordinate system of the camera sensor can be ascertained from the intersection point of these spheres, in particular similarly to a trilateration, a fast, simple and precise field calibration of the hybrid eye-tracking device can advantageously be made possible. Besides trilateration with the three spheres, a further alternative for determining the pose of the LFI sensor could be an iterative method, in which an error function in the form of a gradient is minimized until an ideal/optimal position is ascertained, for example by using a Gausss-Newton algorithm or a Levenberg-Marquardt algorithm.

In addition, a pair of data glasses with a hybrid eye-tracking device is provided according to the present invention, which is preferably calibrable or preferably calibrated by means of the laboratory calibration method and/or by means of the field calibration method. Advantageously, this can result in a cost-effective, robust, user-friendly and precise pair of data glasses.

The hybrid eye-tracking device according to the present invention, the laboratory calibration method according to the present invention, the field calibration method according to the present invention, and the pair of data glasses according to the present invention are not to be limited to the application and embodiments described above. In order to fulfill a functionality described here, the hybrid eye-tracking device according to the present invention, the laboratory calibration method according to the present invention, the field calibration method according to the present invention, and the pair of data glasses according to the present invention can in particular have a number of individual elements, components, units, and method steps that deviates from a number mentioned here. Moreover, for the value ranges specified in this disclosure, values within the mentioned limits are also to be considered disclosed and usable as desired.

### BRIEF DESCRIPTION OF THE DRAWINGS

Further advantages result from the following description of the figures. An embodiment example of the present invention is illustrated in the figures. The disclosure herein contains numerous features in combination. A person skilled in the art will expediently also consider the features individually and combine them to form meaningful further combinations.

FIG. 1 shows a schematic illustration of a pair of data glasses comprising a hybrid eye-tracking device, according to an example embodiment of the present invention.

FIG. 2 shows schematically, a measurement operation by means of LFI sensors of the hybrid eye-tracking device on one eye, according to an example embodiment of the present invention.

FIG. 3 shows a schematic flowchart of a laboratory calibration method for calibrating the hybrid eye-tracking device, according to an example embodiment of the present invention.

FIG. 4 shows schematically, a set-up of a laboratory calibration device for performing the laboratory calibration method, according to an example embodiment of the present invention.

FIG. 5 shows a schematic front view of a laboratory calibration target for the laboratory calibration method, according to an example embodiment of the present invention.

FIG. 6 shows a schematic further view of a portion of the laboratory calibration device, according to an example embodiment of the present invention.

FIG. 7 shows a schematic flowchart of a field calibration method for calibrating the hybrid eye-tracking device, according to an example embodiment of the present invention.

FIG. 8 shows a schematic front view of a field calibration target for the field calibration method, according to an example embodiment of the present invention.

FIG. 9 shows an illustration of a field calibration step of the field calibration method in a coordinate system of a camera sensor of the hybrid eye-tracking device, according to an example embodiment of the present invention.

FIG. 10 shows an illustration of a further field calibration step of the field calibration method in the coordinate system of a camera sensor, according to an example embodiment of the present invention.

### DETAILED DESCRIPTION OF EXAMPLE EMBODIMENTS

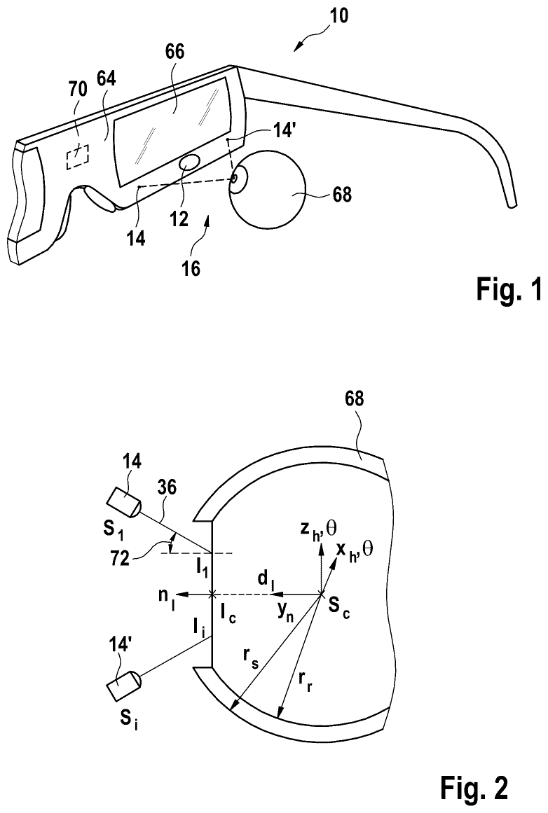

FIG. 1 shows a schematic illustration of a pair of data glasses 10. The pair of data glasses 10 comprises a glasses frame 64. The pair of data glasses 10 comprises glasses lenses 66. The pair of data glasses 10 is provided to display a digital display directly in the field of view of a user, for example via a virtual retinal scan display (not explicitly shown). The pair of data glasses 10 comprises a hybrid eye-tracking device 16. The hybrid eye-tracking device 16 is designed as a high-speed hybrid eye-tracking device. The hybrid eye-tracking device 16 is provided to determine an instantaneous eye position of an eye 68 of a user of the pair of data glasses 10. The hybrid eye-tracking device 16 comprises a camera sensor 12. The camera sensor 12 is designed as an infrared camera sensor. The camera sensor 12 is integrated into the glasses frame 64. The camera sensor 12 is provided to record camera images (frames). The camera sensor 12 is configured at least to determine an eye position of the eye 68 from recorded camera images. The pair of data glasses 10, in particular the hybrid eye-tracking device 16, comprises a computing unit 70. The computing unit 70 may be provided to evaluate the camera images of the camera sensor 12. The computing unit 70 is integrated into the glasses frame 64. However, it is also possible that the computing unit 70 is arranged externally to the pair of data glasses 10 and is only in radio communication with the camera sensor 12. The hybrid eye-tracking device 16 comprises a laser feedback interferometry (LFI) sensor 14. The hybrid eye-tracking device 16 comprises a further LFI sensor 14′. The LFI sensor 14, 14′ is configured at least to determine an instantaneous velocity of an eye movement of the eye 68. The LFI sensor 14, 14′ has a significantly lower resolution than the camera sensor 12. The LFI sensor 14, 14′ has a significantly higher sampling rate than the camera sensor 12.

FIG. 2 schematically shows a measurement operation by means of LFI sensors 14, 14′. The LFI sensor 14 radiates an infrared laser beam in the beam direction 36 onto the eye 68 of the user. Since the LFI sensor 14 can only measure a change in velocity transversely to the beam direction 36 of the laser of the LFI sensor 14, an impingement angle 72 of the laser on a surface of eye 68 must be tracked continuously. The LFI sensor 14 of FIG. 2, which is denoted by S₁ and impinges on the surface of the eye 68 at the intersection point I₁, thus measures a velocity that is incorrect by the impingement angle 72 (angle between n₁ and an extension of the connection between S₁ and I₁).

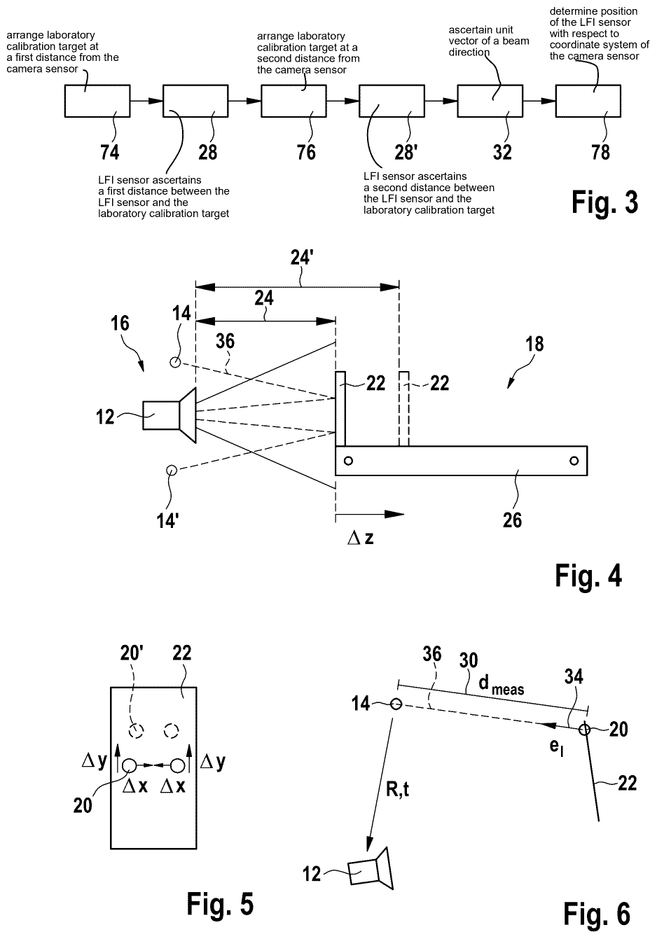

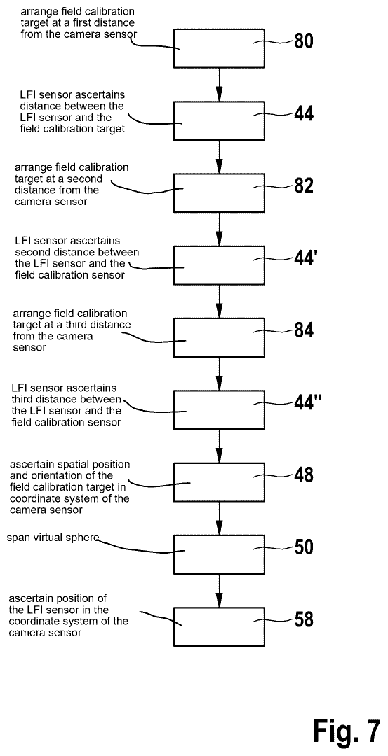

The hybrid eye-tracking device 16 of the pair of data glasses 10 is calibrable by means of a laboratory calibration method (cf. FIG. 3) and/or by means of a field calibration method (cf. FIG. 7). The pair of data glasses 10 is calibrated by means of the laboratory calibration method (cf. FIG. 3) and/or by means of the field calibration method (cf. FIG. 7).

FIG. 3 shows a schematic flowchart of the laboratory calibration method for calibrating the hybrid eye-tracking device 16. FIG. 4 schematically shows a set-up of a laboratory calibration device 18 for performing the laboratory calibration method. The laboratory calibration device 18 comprises a laboratory calibration target 22. The laboratory calibration target 22 can be designed as a planar and monochrome, for example black, plate. Alternatively, however, laboratory calibration targets 22 with patterns and/or multiple colors are also possible. The laboratory calibration device 18 also comprises a precision linear axis 26. The laboratory calibration target 22 is fastened to the precision linear axis 26. The laboratory calibration target 22 is movable by means of the precision linear axis 26. The laboratory calibration target 22 is movable in the z direction by means of the precision linear axis 26. The laboratory calibration target 22 is movable away from the camera sensor 12 and/or toward the camera sensor 12 by means of the precision linear axis 26.

In the laboratory calibration method, a position of the LFI sensor 14, 14′ in a coordinate system of the camera sensor 12 is determined. For this purpose, the camera sensor 12 is used to ascertain positions of a laser point 20 (cf. FIG. 5), generated by the LFI sensor 14, 14′, on the laboratory calibration target 22 at different definable known distances 24, 24′ of the laboratory calibration target 22 from the camera sensor 12 in the coordinate system of the camera sensor 12. The different distances 24, 24′ are set by means of the precision linear axis 26. For this purpose, the laboratory calibration target 22 is moved on the precision linear axis 26 during the laboratory calibration so that the corresponding relative distances 24, 24′ of the laboratory calibration target 22 from the camera sensor 12 are directly readable. In at least one laboratory calibration step 74, the laboratory calibration target 22 is arranged at a first distance 24 from the camera sensor 12. In at least one further laboratory calibration step 28, the LFI sensor 14, 14′ ascertains a first distance 30 between the LFI sensor 14, 14′ and the laboratory calibration target 22 at the location of the laser point 20 on the laboratory calibration target 22. In at least one further laboratory calibration step 76, the laboratory calibration target 22 is arranged at a second distance 24′ from the camera sensor 12. In at least one further laboratory calibration step 28′, the LFI sensor 14, 14′ ascertains a second distance between the LFI sensor 14, 14′ and the laboratory calibration target 22 at the location of the laser point 20 on the laboratory calibration target 22. FIG. 5 shows, by way of example, the laser points 20 on the laboratory calibration target 22 at the two different distances 24, 24′. The centers of the laser points 20 shift in the x direction and in the y direction on the laboratory calibration target 22. In at least one further laboratory calibration step 32, a unit vector 34 of a beam direction 36 of the LFI sensor 14, 14′ is ascertained (cf. FIG. 6) from the horizontal and/or vertical pixel distances (Δx and Δy) between camera images of the same laser point 20 at the different distances 24, 24′ of the laboratory calibration target 22 from the camera sensor 12. In FIG. 6, the measured distance 30 and the ascertained unit vector 34 are marked with the abbreviations dₘₑₐₛ and e₁. The coordinate system of the camera sensor 12 is indicated with the abbreviations R and t. From the consideration of the ascertained distance 30 between the LFI sensor 14, 14′ and the laboratory calibration target 22 and the ascertained unit vector 34 of the beam direction 36 of the LFI sensor 14, 14′, a position of the LFI sensor 14, 14′ with respect to the coordinate system of the camera sensor 12 is then determined in at least one further laboratory calibration step 78. The hybrid eye-tracking device 16 is thus calibrated. The use of the combination of LFI sensors 14 and camera sensor 12 justifies the designation of “hybrid” eye tracking.

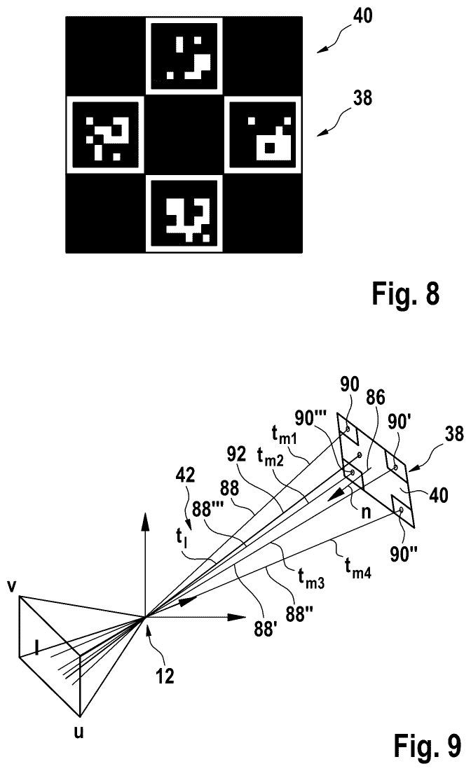

FIG. 7 shows a schematic flowchart of the field calibration method for calibrating the hybrid eye-tracking device 16. In the field calibration method, a position of the LFI sensor 14, 14′ in the coordinate system of the camera sensor 12 is determined. For this purpose, the camera sensor 12 is used to ascertain positions of a laser point 62, generated by the LFI sensor 14, 14′, on a defined and known calibration pattern 38 of an, in particular planar, field calibration target 40 at different definable unknown distances 42 of the field calibration target 40 from the camera sensor 12 in the coordinate system of the camera sensor 12. FIG. 8 shows an exemplary and advantageous embodiment of the field calibration target 40. The field calibration target 40 is planar. The field calibration target 40 is designed as a checkerboard pattern target. The field calibration target 40 has a checkerboard pattern. The field calibration target 40 is designed as a ChArUco pattern target. The field calibration target 40 has a ChArUco pattern. The field calibration target 40 is printable by a user. When performing the field calibration method, the user places the field calibration target 40 at the different distances 42 from the camera sensor 12, which are unknown to the user.

In at least one field calibration step 80, the field calibration target 40 is arranged at a first distance 42 from the camera sensor 12. In at least one further field calibration step 44, the LFI sensor 14, 14′ ascertains a distance 46 between the LFI sensor 14, 14′ and the field calibration target 40 at the location of the laser point 62 on the field calibration target 40. In at least one further field calibration step 82, the field calibration target 40 is arranged at a second distance from the camera sensor 12. In at least one further field calibration step 44′, the LFI sensor 14, 14′ ascertains a second distance 46′ between the LFI sensor 14, 14′ and the field calibration target 40 at the location of the laser point 62 on the field calibration target 40. In at least one further field calibration step 84, the field calibration target 40 is arranged at a third distance from the camera sensor 12. In at least one further field calibration step 44 “, the LFI sensor 14, 14′ ascertains a third distance 46” between the LFI sensor 14, 14′ and the field calibration target 40 at the location of the laser point 62 on the field calibration target 40.

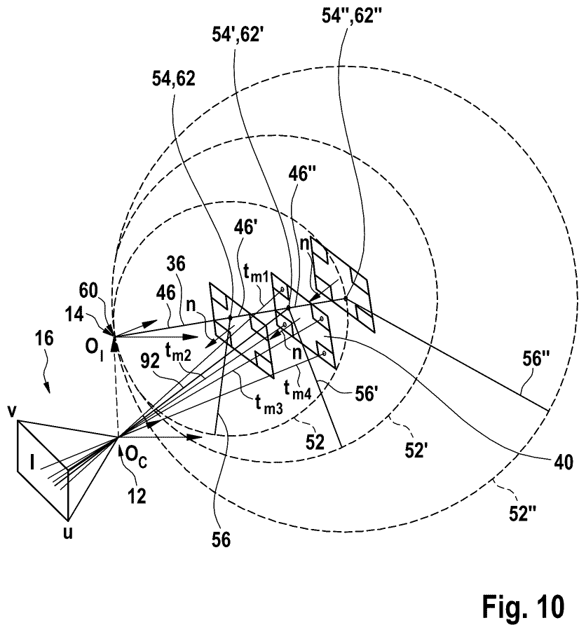

In at least one further field calibration step 48, a spatial position and orientation (cf. also FIG. 9 or 10) of the field calibration target 40 in the coordinate system of the camera sensor 12 are ascertained by means of a checkerboard camera calibration on the basis of a camera image of the camera sensor 12. For this purpose, (here, for example, four) markers 90, 90′, 90″, 90′″ of the defined and known calibration pattern 38 are recognized in the camera image and evaluated to ascertain the position and orientation. In order to ascertain the position and orientation of the field calibration target 40 in space, marker vectors 88, 88′, 88″, 88′″ (denoted by tₘ₁ to tₘ₄ in FIG. 9) pointing to the corresponding markers 90, 90′, 90″, 9′″ are formed in the coordinate system of the camera sensor 12 and evaluated. A normal vector 86 (denoted by n in FIG. 9) of the field calibration target 40 is determined from the ascertained position and orientation of field calibration target 40 in space. In at least one further field calibration step 50, a virtual sphere 52, 52′, 52″ is spanned in the coordinate system of the camera sensor 12 on the basis of the ascertained spatial position and orientation of the field calibration target 40. The centers 54, 54′, 54″ of these virtual spheres 52, 52′, 52″ are formed by the corresponding position of the laser point 62, 62′, 62″ on the field calibration target 40 at the different, initially unknown distances 42. The radii 56, 56′, 56″ of the virtual spheres 52, 52′, 52″ are formed by the corresponding distances 46, 46′, 46″ between the LFI sensor 14, 14′ and the field calibration target 40 at the location of the corresponding laser point 62, 62′, 62′″ on the field calibration target 40. In at least one further field calibration step 58, for at least three unknown distances 42 of the field calibration target 40 from the camera sensor 12, a separate virtual sphere 52, 52′, 52″ is in each case spanned in the coordinate system of the camera sensor 12 so that the position of the LFI sensor 14, 14′ in the coordinate system of the camera sensor 12 can be ascertained from an intersection point 60 of these virtual spheres 52, 52′, 52″. The position of the LFI sensor 14, 14′ in the coordinate system of the camera sensor 12 is thus ascertained by some form of trilateration via three spatial virtual spheres 52, 52′, 52″. A laser vector 92 of the LFI sensor 14 in the coordinate system of the camera sensor 12 is marked with the abbreviation t₁ in FIG. 9. The hybrid eye-tracking device 16 is thus calibrated or recalibrated. The field calibration method is preferably used for a recalibration, while the laboratory calibration method is preferably used for an initial calibration.

1-12. (canceled)

13. A hybrid eye-tracking device for determining an instantaneous eye position of an eye of a user of data glasses, comprising:
at least one camera sensor; and
at least one laser feedback interferometry sensor;
wherein the camera sensor is configured at least to determine an eye position from a camera image; and
wherein the LFI sensor is configured at least to determine an instantaneous velocity of an eye movement.

14. The hybrid eye-tracking device, according to claim 13, wherein the LFI sensor has a significantly lower resolution and a significantly higher sampling rate than the camera sensor.

15. A laboratory calibration method for calibrating a hybrid eye-tracking device, the hybrid eye-tracking device including:
at least one camera sensor, and
at least one laser feedback interferometry sensor,
wherein the camera sensor is configured at least to determine an eye position from a camera image, and
wherein the LFI sensor is configured at least to determine an instantaneous velocity of an eye movement,
the laboratory calibration method comprising:
determining a position of the LFI sensor in a coordinate system of the camera sensor by using the camera sensor to ascertain positions of a laser point, generated by the LFI sensor, on a planar and monochrome laboratory calibration target at different definable known distances of the laboratory calibration target from the camera sensor in the coordinate system of the camera sensor.

16. The laboratory calibration method according to claim 15 wherein the laboratory calibration target is moved on a precision linear axis during calibration so that corresponding relative distances of the laboratory calibration target from the camera sensor are directly readable.

17. The laboratory calibration method according to claim 15, wherein, in at least one laboratory calibration step, the LFI sensor ascertains a distance between the LFI sensor and the laboratory calibration target at a location of the laser point.

18. The laboratory calibration method according to claim 15, wherein, in at least one laboratory calibration step, a unit vector of a beam direction of the LFI sensor is ascertained from horizontal and/or vertical pixel distances between camera images of the same laser point at the different distances of the laboratory calibration target from the camera sensor.

19. A field calibration method for calibrating a hybrid eye-tracking device, the hybrid eye-tracking device including:
at least one camera sensor, and
at least one laser feedback interferometry sensor,
wherein the camera sensor is configured at least to determine an eye position from a camera image, and
wherein the LFI sensor is configured at least to determine an instantaneous velocity of an eye movement,
the field calibration method comprising:
determining a position of the LFI sensor in a coordinate system of the camera sensor by using the camera sensor to ascertain positions of a laser point, generated by the LFI sensor, on a defined and known calibration pattern of a planar, field calibration target including a checkerboard pattern target at different unknown distances of the field calibration target from the camera sensor in the coordinate system of the camera sensor.

20. The field calibration method according to claim 19, wherein, in at least one field calibration step, the LFI sensor ascertains a distance between the LFI sensor and the field calibration target at a location of the laser point.

21. The field calibration method according to claim 20, wherein, in at least one field calibration step, a spatial position and orientation of the field calibration target in the coordinate system of the camera sensor are ascertained using a checkerboard camera calibration based on a camera image of the camera sensor.

22. The field calibration method according to claim 21, wherein, in at least one further field calibration step, based on the ascertained spatial position and orientation of the field calibration target, a virtual sphere, a center of which is formed by the laser point on the field calibration target and a radius of which is formed by the distance between the LFI sensor and the field calibration target at the location of the laser point, is spanned in the coordinate system of the camera sensor.

23. The field calibration method according to claim 22, wherein, in the further field calibration step, for at least three unknown distances of the field calibration target from the camera sensor, a separate virtual sphere is in each case spanned in the coordinate system of the camera sensor so that the position of the LFI sensor in the coordinate system of the camera sensor can be ascertained from the intersection point of the virtual spheres.

24. A pair of data glasses, comprising:
a hybrid eye-tracking device for determining an instantaneous eye position of an eye of a user of the data glasses, including:
at least one camera sensor, and
at least one laser feedback interferometry sensor,
wherein the camera sensor is configured at least to determine an eye position from a camera image, and
wherein the LFI sensor is configured at least to determine an instantaneous velocity of an eye movement.

25. The pair of data glasses according to claim 24, wherein the hybrid eye-tracking device is calibrated by determining a position of the LFI sensor in a coordinate system of the camera sensor by using the camera sensor to ascertain positions of a laser point, generated by the LFI sensor, on a planar and monochrome laboratory calibration target at different definable known distances of the laboratory calibration target from the camera sensor in the coordinate system of the camera sensor.

26. The pair of data glasses according to claim 25, wherein the hybrid eye-tracking device is calibrated by determining a position of the LFI sensor in a coordinate system of the camera sensor by using the camera sensor to ascertain positions of a laser point, generated by the LFI sensor, on a defined and known calibration pattern of a planar, field calibration target including a checkerboard pattern target at different unknown distances of the field calibration target from the camera sensor in the coordinate system of the camera sensor.
